(19) United States
(12) Patent Application Publication
(10) Pub. No.: US 2026/0301326 A1
(43) Pub. Date: Oct. 1, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: DAISUKE TAJIMA, TOKYO (JP); MIWA ICHIKAWA, TOKYO (JP)

(21) Appl. No.: 19/489,901

(22) PCT Filed: Jun. 10, 2024
(86) PCT No.: PCT/JP2024/020986

§ 371 Date: Dec. 4, 2025

(30) Foreign Application Priority Data
Jun. 28, 2023 (JP) 2023-106292

(51) Int. Cl. G06T 19/00; G06V 20/64; G06V 40/10; G09B 5/02

(52) U.S. Cl. CPC G06T 19/00; G06V 20/647; G06V 40/11; G09B 5/02; G06T 2200/24; G06T 2219/024

(57) ABSTRACT

The present disclosure relates to an information processing apparatus, an information processing method, and a program capable of performing better remote work support. An update image acquisition unit acquires an update image to be used for updating 3D data among images obtained by capturing a work target object, an update part specification unit compares the 3D data of the work target object already created with the update image to specify an update part of the 3D data of the work target object, and a 3D data update unit updates a part of the 3D data of the work target object using the update image. The present technology can be applied to, for example, a remote work support system.

### TECHNICAL FIELD

The present disclosure relates to an information processing apparatus, an information processing method, and a program, and more particularly, to an information processing apparatus, an information processing method, and a program capable of performing better remote work support.

### BACKGROUND ART

Conventionally, in a case where a facility trouble occurs at a manufacturing site or the like, an instructor (for example, an expert in an office, home, or the like) at a remote place away from the manufacturing site may instruct a worker at the manufacturing site on a method of recovering from the facility trouble, work contents, and the like. In such a case, the instructor can remotely perform appropriate instruction and support while confirming the 3D data of the facility created from the image captured in advance.

For example, Patent Document 1 discloses a technique for calibrating external parameters of a plurality of imaging apparatuses arranged at different positions in a technique for reproducing a three-dimensional shape of a subject from images captured by the plurality of imaging apparatuses.

### CITATION LIST

### Patent Document

Patent Document 1: WO 2019/225681 A

### SUMMARY OF THE INVENTION

### Problems to be Solved by the Invention

By the way, conventionally, since the 3D data of the facility confirmed by the instructor is created from an image captured in advance, when the worker at the site requests an instruction, it is assumed that the situation is different from the actual facility. For example, a display content of an operation panel provided in a facility or the like is sequentially changed by an operation by a worker. Therefore, conventionally, it has been difficult to satisfactorily perform remote work support.

The present disclosure has been made in view of such a situation, and an object thereof is to implement better remote work support.

### Solutions to Problems

An information processing apparatus according to one aspect of the present disclosure includes: an update image acquisition unit that acquires an update image to be used for updating 3D data among images obtained by capturing a work target object; an update part specification unit that compares the 3D data of the work target object already created with the update image to specify an update part of the 3D data of the work target object; and a 3D data update unit that updates a part of the 3D data of the work target object using the update image.

An information processing method or a program according to one aspect of the present disclosure includes: acquiring an update image to be used for updating 3D data among images obtained by capturing a work target object; comparing the 3D data of the work target object already created with the update image to specify an update part of the 3D data of the work target object; and updating a part of the 3D data of the work target object using the update image.

According to one aspect of the present disclosure, an update image to be used for updating 3D data is acquired from among images obtained by capturing a work target object, an update part of the 3D data of the work target object is specified by comparing the 3D data of the work target object already created with the update image, and a part of the 3D data of the work target object is updated using the update image.

### BRIEF DESCRIPTION OF DRAWINGS

FIG. 1 is a diagram for explaining a configuration example and a use example of an embodiment of a remote work support system to which the present technology is applied.

FIG. 2 is a diagram for explaining a processing process of 3D data reading processing and 3D data update processing.

FIG. 3 is a block diagram illustrating a configuration example of a remote work support system that executes 3D data update processing.

FIG. 4 is a flowchart for explaining 3D data update processing on the client terminal side.

FIG. 5 is a flowchart for explaining update image processing.

FIG. 6 is a flowchart for explaining 3D data update processing on the server side.

FIG. 7 is a block diagram illustrating a configuration example of a smartphone used as a client terminal.

FIG. 8 is a diagram for explaining an overview of pointing UI processing.

FIG. 9 is a diagram for explaining display of a pointing UI object.

FIG. 10 is a block diagram illustrating a configuration example of a remote work support system that executes pointing UI processing.

FIG. 11 is a flowchart for explaining pointing UI processing.

FIG. 12 is a diagram for explaining a change in display of the pointing UI object with the lapse of time.

FIG. 13 is a diagram for explaining an example of a change in color saturation and size of a pointing UI object.

FIG. 14 is a diagram for explaining display change according to a plurality of pointing UI objects existing within a certain range.

FIG. 15 is a diagram for explaining a change to display a pointing UI object having a size to cover a plurality of pointing UI objects.

FIG. 16 is a diagram for explaining a change to display a past pointing UI object in an original conspicuous state.

FIG. 17 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

### Configuration Example and Use Example of Remote Work Support System

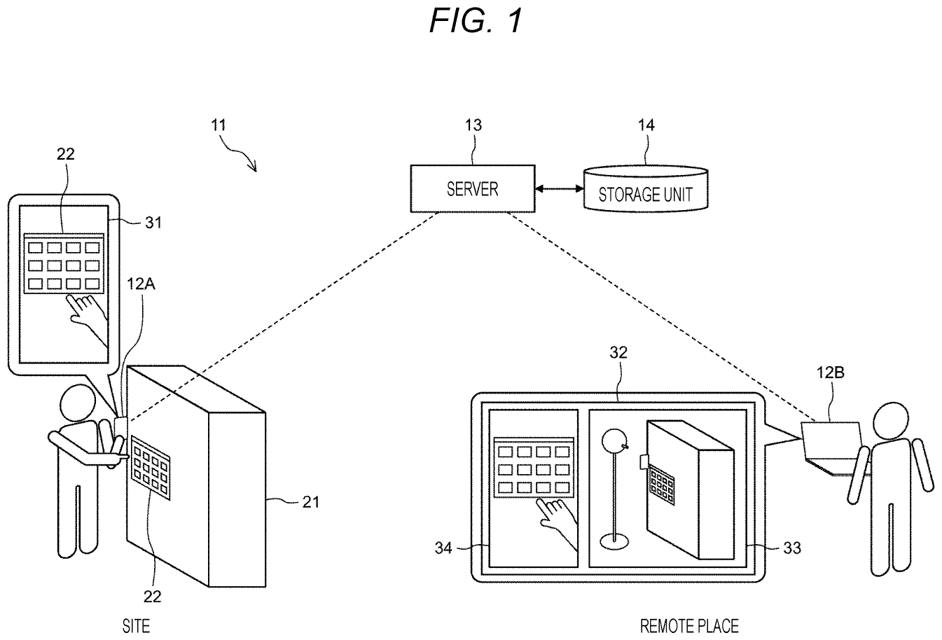

A configuration example of a remote work support system to which the present technology is applied and a use example of remote work support using the remote work support system will be described with reference to FIG. 1.

As illustrated in FIG. 1, in a remote work support system 11, a client terminal 12A and a client terminal 12B are connected to a server 13 via a network, and the server 13 includes a storage unit 14.

In the use example illustrated in FIG. 1, a worker on site uses the client terminal 12A, and an instructor in a remote place uses the client terminal 12B. For example, in order to explain the situation of the site to the instructor when responding to a trouble, the worker can capture the current state of a facility 21, which is the work target object, by the camera of the client terminal 12A.

The client terminal 12A transmits, to the server 13, an update image to be used for updating the 3D data in the server 13 among images of the facility 21 captured by the camera. For example, when the worker captures a part of the facility 21 that conveys the situation of the site to the instructor or is necessary for the instruction from the instructor, an important part of the facility 21 is displayed in the update image. In the example illustrated in FIG. 1, the worker captures an operation panel 22 provided in the facility 21 with the client terminal 12A, and an image showing the operation panel 22 is displayed on a screen 31 of the client terminal 12A.

The storage unit 14 stores 3D data (three-dimensional scan data, AR map data, and the like) of c the facility 21 to be worked by the worker. For example, the 3D data of the facility 21 is created by imaging the facility 21 in advance.

The server 13 compares the update image of the facility 21 transmitted from the client terminal 12A with the 3D data of the facility 21 stored in the storage unit 14, specifies a part to be an update part of the 3D data of the facility 21, and updates only the part using the update image. For example, feature point matching as described later can be used to specify the update part of the 3D data of the facility 21. As a result, the server 13 can bring the 3D data of the facility 21 stored in the storage unit 14 into the latest state (for example, the current display content of the operation panel 22) during capturing by the worker. Then, the server 13 transmits the 3D data of the facility 21 in the latest state to the client terminal 12B.

The client terminal 12B generates a virtual object of the facility 21 on the basis of the latest 3D data of the facility 21 transmitted from the server 13, arranges the virtual object in a virtual space, and displays a VR image 33 obtained by rendering the virtual space from a desired viewpoint (for example, a viewpoint from which it is easy to instruct the worker) on the screen 32. Furthermore, in the example illustrated in FIG. 1, the screen 32 of the client terminal 12B also displays a captured image 34 being captured by the camera of the client terminal 12A (the same image as that displayed on the screen 31 of the client terminal 12A). As a result, the instructor can give an instruction or the like to the worker at the site while confirming the VR image 33 and the captured image 34 based on the facility 21 in the latest state.

As described above, in the remote work support system 11, the 3D data update processing of sequentially updating only a part of the 3D data of the facility 21 corresponding to the update image is performed using the update image sequentially transmitted from the client terminal 12A to the server 13. As a result, in the remote work support system 11, the 3D data of the facility 21 transmitted to the client terminal 12B can always be in the latest state, and more favorable remote work support can be performed.

For example, in the 3D data of the facility 21 created from the image captured in advance, when the worker at the site requests an instruction, it is assumed that the situation is different from the actual facility, and a situation is assumed in which the instructor cannot give an appropriate instruction. On the other hand, in the remote work support system 11, such a situation can be avoided. In particular, even when the state of the display content of the operation panel 22 is sequentially changed by the operation by the worker, the instructor can confirm and instruct the latest display content of the operation panel 22.

Furthermore, in the remote work support system 11, by updating only a part of the 3D data (an important part that the worker feels that the instruction or support is necessary), for example, the amount of calculation for matching or the like in the server 13 can be reduced as compared with updating the entire 3D data. As a result, the 3D data transmitted to the client terminal 12B can be updated to the latest state in more real time.

Furthermore, in the remote work support system 11, in a case where it is detected that a body part such as a hand of the worker is reflected in the image being captured by the camera of the client terminal 12A, an image section before and after the body part is not reflected, an image region in which the body part is not reflected, or the like can be used as the update image. As a result, in the remote work support system 11, even in a case where the facility 21 is partially hidden due to the reflection of the body part of the worker, the 3D data of the facility 21 can be updated more reliably.

Note that, in addition to the smartphone as illustrated in FIG. 1, a head-mounted display (AR HMD: Augmented Reality Head Mounted Display) for augmented reality, a tablet, or the like can be used as the client terminal 12A. Furthermore, as the client terminal 12B, a head-mounted display (VR HMD: Virtual Reality Head Mounted Display) for virtual reality or the like can be used in addition to the personal computer as illustrated in FIG. 1.

Here, the remote work support system 11 can be configured to have the same function when the client terminal 12A and the client terminal 12B execute a common remote work support application. Therefore, hereinafter, the client terminal 12A and the client terminal 12B having the same function are simply referred to as client terminals 12. Of course, the client terminal 12A may include only the functions necessary for the worker at the site among the functions provided by executing the remote work support application. Similarly, the client terminal 12B may include only a function required by the instructor at a remote place among functions provided by executing the remote work support application.

### Processing Example of 3D Data Update Processing

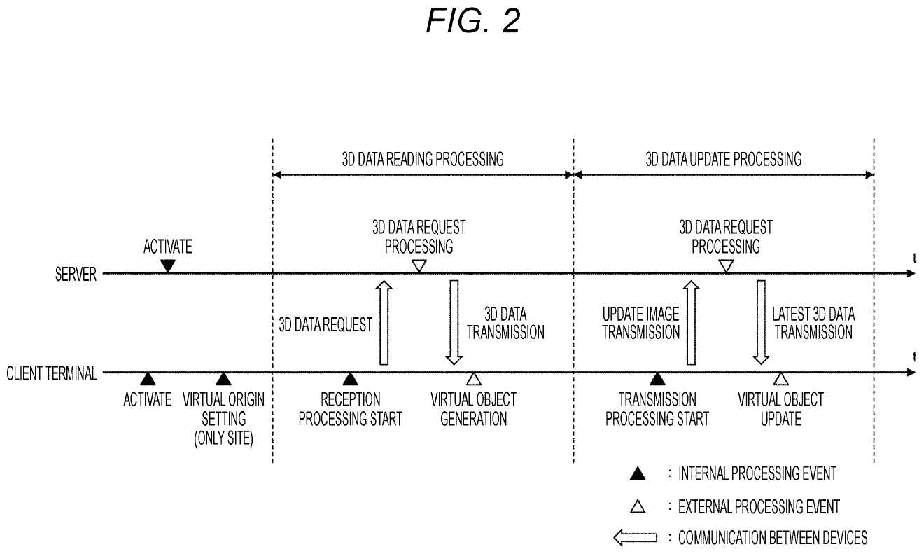

3D data update processing of sequentially updating a part of the 3D data in the remote work support system 11 will be described with reference to FIGS. 2 to 7.

FIG. 2 is a diagram for explaining a processing process of 3D data reading processing and 3D data update processing.

First, in the remote work support system 11, the client terminal 12 is activated to execute the remote work support application, and the server 13 is activated. Then, the client terminal 12A on the site side uses an AR marker, a visual positioning system/service (VPS), or the like to set, for example, an origin position of virtual coordinates common to the created 3D data.

Next, the remote work support system 11 performs 3D data reading processing. The client terminal 12 performs an internal processing event for starting the reception processing and performs communication for requesting the server 13 to transmit the 3D data. The server 13 performs an external processing event for executing 3D data request processing in response to a request from the client terminal 12, and performs communication for transmitting 3D data in response to the request from the client terminal 12. The client terminal 12 performs an external processing event of generating a virtual object on the basis of the 3D data transmitted from the server 13, and arranges the virtual object in the virtual space.

Subsequently, the remote work support system 11 performs 3D data update processing. The client terminal 12 performs an internal processing event for starting the transmission processing and performs communication for transmitting the update image to the server 13. The server 13 performs an external processing event of executing 3D data update processing of partially updating the 3D data using the update image transmitted from the client terminal 12, and performs communication of transmitting the 3D data in the latest state to the client terminal 12. The client terminal 12 performs an external processing event of updating the virtual object on the basis of the latest 3D data transmitted from the server 13, and partially updates the virtual object arranged in the virtual space.

As described above, in the remote work support system 11, in the 3D data reading processing, the client terminal 12 can read the 3D data from the server 13 and generate the virtual object. Then, in the 3D data update processing, the client terminal 12 transmits the update image to the server, and can partially update the virtual object on the basis of the latest 3D data updated by the server 13 by the update image.

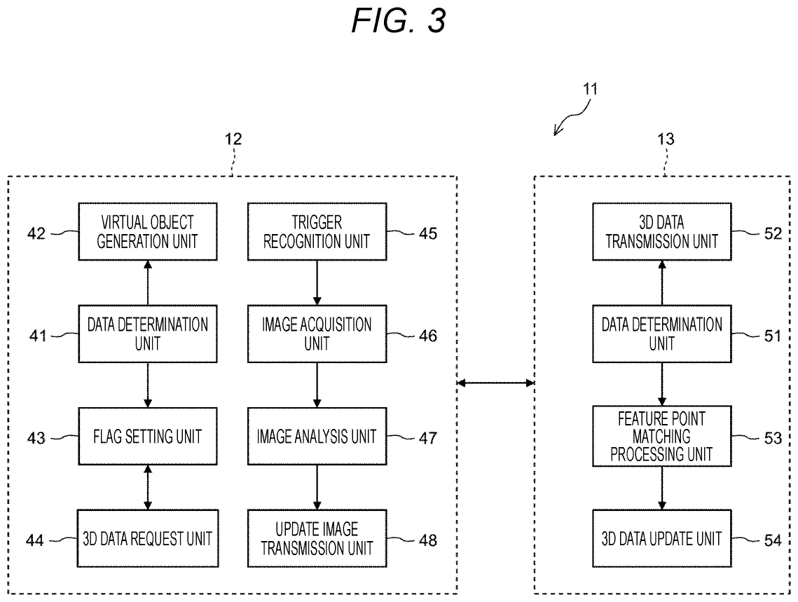

FIG. 3 is a block diagram illustrating a functional configuration example of the client terminal 12 and the server 13 that execute the 3D data update processing.

The client terminal 12 includes a data determination unit 41, a virtual object generation unit 42, a flag setting unit 43, a 3D data request unit 44, a trigger recognition unit 45, an image acquisition unit 46, an image analysis unit 47, and an update image transmission unit 48. The server 13 includes a data determination unit 51, a 3D data transmission unit 52, a feature point matching processing unit 53, and a 3D data update unit 54.

The data determination unit 41 determines whether or not data has been received for the data transmitted from the server 13, determines whether the type of data is 3D data or 3D data update notification, and the like. For example, the data determination unit 41 supplies the 3D data to the virtual object generation unit 42 in a case of determining that the type of data transmitted from the server 13 is the 3D data, and supplies the 3D data update notification to the flag setting unit 43 in a case of determining that the type of data transmitted from the server 13 is the 3D data update notification.

The virtual object generation unit 42 generates a virtual object on the basis of the 3D data transmitted from the server 13. Then, the virtual object generation unit 42 arranges the generated virtual object in the virtual space or updates the virtual object already arranged in the virtual space.

In accordance with the 3D data update notification transmitted from the server 13, the flag setting unit 43 sets a 3D data request flag indicating that the 3D data is requested to the server 13 on the basis of the presetting. For example, the presetting regarding the 3D data request flag can be changed by the platform of the client terminal 12 or the user setting. For example, in the case of a smartphone used on site such as the client terminal 12A, the 3D data update notification is ignored and the presetting is performed in which the 3D data request flag is not set. In addition, in the case of a personal computer used at a remote place such as the client terminal 12B, presetting is performed so as to set the 3D data request flag whenever the 3D data update notification is transmitted.

In a case where the 3D data request flag is set in the flag setting unit 43, the 3D data request unit 44 requests the server 13 for 3D data according to the 3D data update notification.

The trigger recognition unit 45 recognizes generation of an update image acquisition trigger which is a trigger for acquiring the update image. For example, the trigger recognition unit 45 can recognize the generation of the update image acquisition trigger at the timing when the conversation between the instructor and the worker is started, the timing when the capturing start operation is performed by the worker, and the timing when the time during which the smartphone is at the same position becomes longer than a predetermined time. In particular, the trigger recognition unit 45 may recognize the occurrence of the update image acquisition trigger in a case where an instruction word such as “this” or “that” is included in the conversation between the instructor and the worker, or in a case where the worker manually instructs or designates a specific location, range, or the like. Then, when recognizing generation of the update image acquisition trigger, the trigger recognition unit 45 instructs the image acquisition unit 46 to acquire the image.

In accordance with an instruction from the trigger recognition unit 45, the image acquisition unit 46 acquires images of a certain period before and after the update image acquisition trigger, and supplies the images to the image analysis unit 47. Furthermore, the image acquisition unit 46 may acquire an image several minutes before the update image acquisition trigger is recognized.

The image analysis unit 47 analyzes the image supplied from the image acquisition unit 46, and acquires the update image on the basis of the analysis result. Then, in a case where it is detected that the body part such as the hand of the worker is shown in the image on the basis of the analysis result of the image, the image analysis unit 47 can specify the image section before and after the body part is not shown, the image region in which the body part is not shown, and the like as the target of the update image. In addition, in a case where the hand of the worker shown in the image has a pointing shape and an object exists within a certain range of a point pointed by the worker, the image analysis unit 47 can specify the image including the object as the target of the update image on the basis of the analysis result of the image.

The update image transmission unit 48 transmits the update image specified by the image analysis unit 47 among the images acquired by the image acquisition unit 46 to the server 13.

The data determination unit 51 determines whether or not data has been received for the data transmitted from the client terminal 12, determines whether the type of the data is the 3D data request or the update image, and the like. For example, in a case of determining that the type of data transmitted from the client terminal 12 is the 3D data request, the data determination unit 41 supplies the 3D data request to the 3D data transmission unit 52, and in a case of determining that the type of data transmitted from the client terminal 12 is the update image, the data determination unit supplies the update image to the feature point matching processing unit 53.

The 3D data transmission unit 52 transmits the 3D data according to the 3D data request transmitted from the client terminal 12 to the client terminal 12.

The feature point matching processing unit 53 performs feature point matching between the update image transmitted from the client terminal 12 and the 3D data corresponding to the work target object on site, and calculates a matching degree of the feature point matching. Then, in a case where the matching degree of the feature point matching is the set value or more, the feature point matching processing unit 53 supplies the update image transmitted from the client terminal 12 to the 3D data update unit 54.

The 3D data update unit 54 updates a part (for example, texture) of the 3D data corresponding to the update image transmitted from the client terminal 12 among the 3D data corresponding to the work target object at the site using the update image. Then, the 3D data update unit 54 performs 3D data update notification for notifying the client terminal 12 that a part of the 3D data has been updated.

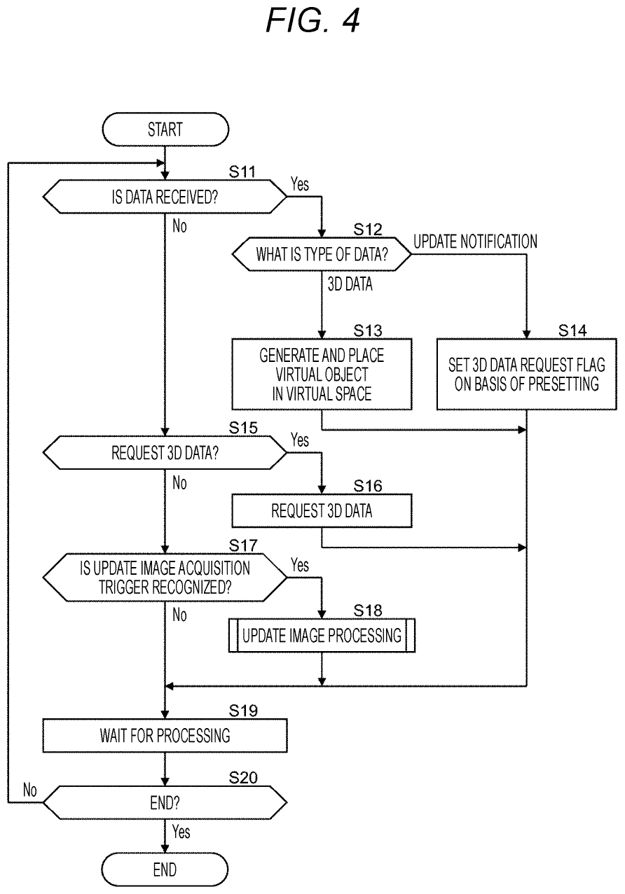

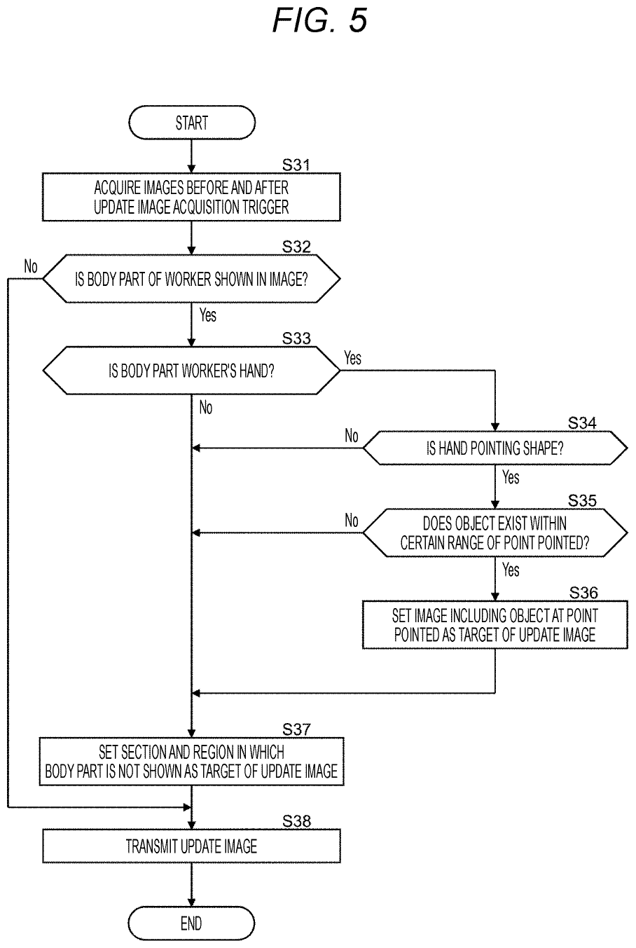

3D data update processing executed in the client terminal 12 will be described with reference to flowcharts illustrated in FIGS. 4 and 5.

When the remote work support application is executed in the client terminal 12, the processing is started, and in step S11, the data determination unit 41 determines whether or not data transmitted from the server 13 has been received.

In step S11, in a case where the data determination unit 41 determines that the data transmitted from the server 13 is received, the processing proceeds to step S12.

In step S12, the data determination unit 41 determines whether the type of the data transmitted from the server 13 is the 3D data or the 3D data update notification.

In step S12, in a case where the data determination unit 41 determines that the type of data transmitted from the server 13 is 3D data, the 3D data is supplied to the virtual object generation unit 42, and the processing proceeds to step S13. In step S13, the virtual object generation unit 42 generates a virtual object on the basis of the 3D data transmitted from the server 13 and arranges the virtual object in the virtual space.

On the other hand, in step S12, in a case where the data determination unit 41 determines that the type of data transmitted from the server 13 is the 3D data update notification, the 3D data update notification is supplied to the flag setting unit 43, and the processing proceeds to step S14. In step S14, the flag setting unit 43 sets the 3D data request flag indicating that the 3D data is requested to the server 13 on the basis of the presetting as described above.

Then, after the processing of step S13 or step S14, the processing proceeds to step S19.

On the other hand, in step S11, in a case where the data determination unit 41 determines that the data transmitted from the server 13 has not been received, the processing proceeds to step S15.

In step S15, the 3D data request unit 44 determines whether or not to request the server 13 to transmit the 3D data according to the flag set in the flag setting unit 43. That is, in a case where the 3D data request flag is set in the flag setting unit 43, the 3D data request unit 44 determines to request the server 13 to transmit the 3D data.

In step S15, in a case where the 3D data request unit 44 determines to request the server 13 to transmit the 3D data, the processing proceeds to step S16. In step S16, the 3D data request unit 44 requests the server 13 for the 3D data according to the 3D data update notification, and then the processing proceeds to step S19.

On the other hand, in step S15, in a case where the 3D data request unit 44 determines not to request the server 13 to transmit the 3D data, the processing proceeds to step S17.

In step S17, the trigger recognition unit 45 determines whether or not the generation of the update image acquisition trigger instructing the acquisition of the update image is recognized.

In step S17, in a case where the trigger recognition unit 45 determines that the generation of the update image acquisition trigger is recognized, the processing proceeds to step S18, and the update image processing described later with reference to FIG. 5 is performed.

On the other hand, in step S17, in a case where the trigger recognition unit 45 determines that the generation of the update image acquisition trigger is not recognized, or after the processing of step S18, the processing proceeds to step S19.

In step S19, the client terminal 12 waits for the processing in accordance with a predetermined waiting time, and thereafter, the processing proceeds to step S20.

In step S20, the client terminal 12 determines whether or not to end the 3D data update processing according to, for example, an operation input by the worker.

In step S20, in a case where the client terminal 12 determines not to end the 3D data update processing, the processing returns to step S11, and similar processing is repeatedly performed thereafter. On the other hand, in a case where the client terminal 12 determines to end the 3D data update processing in step S20, the processing is ended.

FIG. 5 is a flowchart for explaining the update image processing in step S18 of FIG. 4.

In step S31, the image acquisition unit 46 acquires images before and after the update image acquisition trigger recognized by the trigger recognition unit 45 and supplies the images to the image analysis unit 47, and the image analysis unit 47 analyzes the images.

In step S32, the image analysis unit 47 determines whether or not the body part of the worker is shown in the image on the basis of the analysis result obtained by analyzing the image in step S31. In step S32, in a case where the image analysis unit 47 determines that the body part of the worker is shown in the image, the processing proceeds to step S33.

In step S33, the image analysis unit 47 determines whether or not the body part shown in the image is the hand of the worker on the basis of the analysis result obtained by analyzing the image in step S31. In step S33, in a case where the image analysis unit 47 determines that the body part shown in the image is the hand of the worker, the processing proceeds to step S34.

In step S34, the image analysis unit 47 determines whether or not the hand of the worker shown in the image has a pointing shape. In step S34, in a case where the image analysis unit 47 determines that the worker's hand shown in the image has a pointing shape, the processing proceeds to step S35.

In step S35, the image analysis unit 47 determines whether or not an object is present within a certain range of the point pointed by the worker. In step S35, in a case where the image analysis unit 47 determines that an object is present within the certain range of the point pointed by the worker, the processing proceeds to step S36.

In step S36, the image analysis unit 47 sets the image including the object at the point pointed by the worker as a target of the update image, and supplies the update image to the update image transmission unit 48. Thereafter, the processing proceeds to step S37.

In addition, in a case where it is determined in step S33 that the body part shown in the image is not the hand of the worker, in a case where it is determined in step S34 that the hand of the worker shown in the image does not have the pointing shape, and in a case where it is determined in step S35 that the object does not exist within the certain range of the point pointed by the worker, the processing proceeds to step S37.

In step S37, the image analysis unit 47 sets, as a target of the update image, the image sections before and after in which body parts are not shown, the image region in which the body part is not shown, and the like in the image acquired in step S31, and supplies the update image to the update image transmission unit 48.

In addition, in a case where it is determined in step S32 that the body part of the worker is not shown in the image, or after the processing in step S37, the processing proceeds to step S38.

In step S38, the update image transmission unit 48 transmits the update image to the server 13, and then the update image processing is ended.

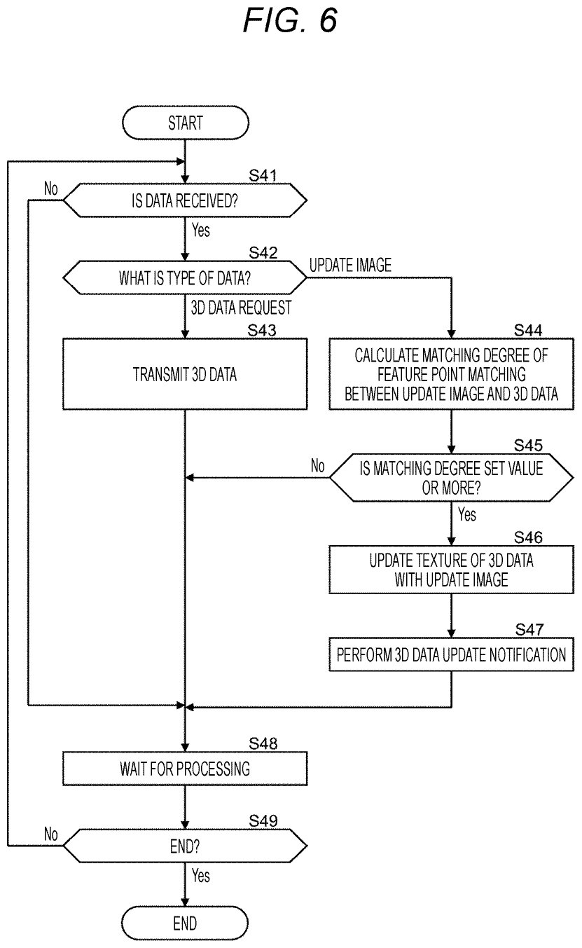

3D data update processing executed in the server 13 will be described with reference to the flowchart illustrated in FIG. 6.

In step S41, the data determination unit 51 determines whether or not data transmitted from the client terminal 12 has been received.

In step S41, in a case where the data determination unit 51 determines that the data transmitted from the client terminal 12 is received, the processing proceeds to step S42.

In step S42, the data determination unit 51 determines whether the type of the data transmitted from the client terminal 12 is the 3D data request or the update image.

In step S42, in a case where the data determination unit 51 determines that the type of data transmitted from the server 13 is the 3D data request, the 3D data request is supplied to the 3D data transmission unit 52, and the processing proceeds to step S43. In step S43, the 3D data transmission unit 52 transmits the 3D data to the client terminal 12 in response to the 3D data request from the client terminal 12.

On the other hand, in step S42, in a case where the data determination unit 51 determines that the type of the data transmitted from the server 13 is the update image, the update image is supplied to the feature point matching processing unit 53, and the processing proceeds to step S44. In step S44, the feature point matching processing unit 53 performs feature point matching between the update image transmitted from the client terminal 12 and the 3D data corresponding to the work target on site, and calculates a matching degree of the feature point matching.

In step S45, the feature point matching processing unit 53 determines whether or not the matching degree of the feature point matching obtained in step S44 is a set value or more.

In step S45, in a case where the feature point matching processing unit 53 determines that the matching degree is a set value or more, the processing proceeds to step S46. In step S46, the 3D data update unit 54 updates the texture of the 3D data in the region corresponding to the update image transmitted from the client terminal 12 among the 3D data corresponding to the work target on site with the update image.

In step S47, the 3D data update unit 54 performs 3D data update notification for notifying the client terminal 12 that a part of the 3D data has been updated.

By executing the 3D data update processing as described above by the client terminal 12 and the server 13, it is possible to bring the 3D data of the work target in the portion for which the worker requires the instruction from the instructor into the latest state. In addition, even in a case where a body part such as a hand of the worker is reflected in the image captured by the client terminal 12, the 3D data can be updated by the update image in which the body part is not reflected.

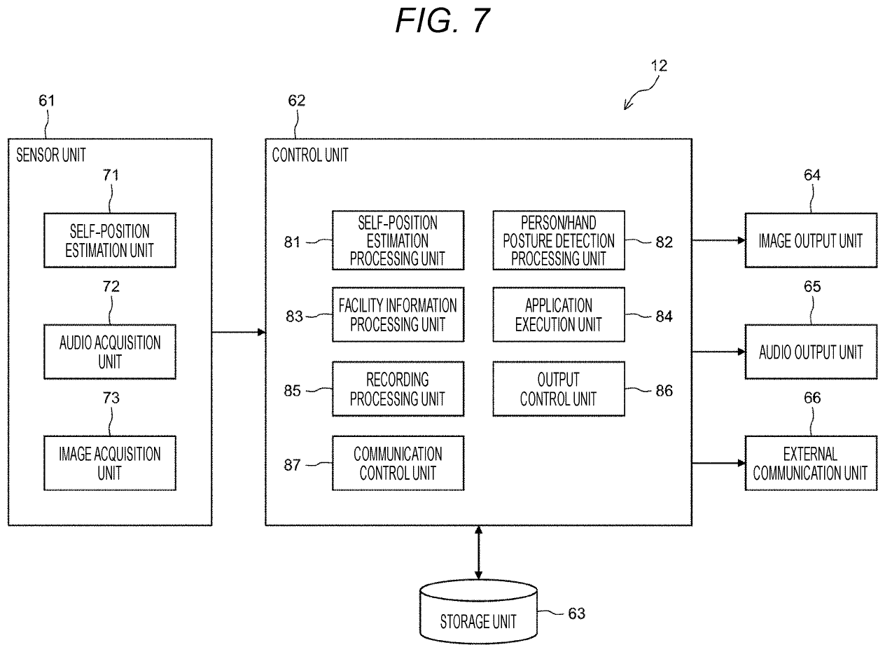

FIG. 7 is a block diagram illustrating a configuration example in a case where a smartphone is used as the client terminal 12.

As illustrated in FIG. 7, the client terminal 12 includes a sensor unit 61, a control unit 62, a storage unit 63, an image output unit 64, an audio output unit 65, and an external communication unit 66.

The sensor unit 61 includes a self-position estimation unit 71, an audio acquisition unit 72, and an image acquisition unit 73.

The self-position estimation unit 71 acquires sensor data necessary for estimating the self-position of the client terminal 12 using, for example, an acceleration sensor, a gyro sensor, simultaneous localization and mapping (SLAM), an orientation sensor, or the like, and supplies the sensor data to the control unit 62. Furthermore, the self-position estimation unit 71 may use a depth sensor.

The audio acquisition unit 72 acquires the voice of the user using a microphone or the like, and supplies the voice to the control unit 62. For example, the voice acquired by the audio acquisition unit 72 can be used to recognize the occurrence of the update image acquisition trigger.

The image acquisition unit 73 acquires an image using a camera or the like, and supplies the image to the control unit 62.

The control unit 62 includes a self-position estimation processing unit 81, a person/hand posture detection unit 82, a facility information processing unit 83, an application execution unit 84, a recording processing unit 85, an output control unit 86, and a communication control unit 87.

The self-position estimation processing unit 81 estimates the self-location of the client terminal 12 on the basis of the sensor data (for example, acceleration data, angular velocity data, SLAM data, orientation data, and the like) supplied from the self-position estimation unit 71. For example, the self-position of the client terminal 12 estimated by the self-position estimation processing unit 81 can be used to set the origin position of the virtual coordinates of the 3D data.

The person/hand posture detection unit 82 analyzes the image supplied from the image acquisition unit 73, and detects the posture of the user, the posture of the hand, and the like shown in the image. For example, the posture of the hand detected by the person/hand posture detection unit 82 is used for determining whether or not the hand of the worker shown in the image has a pointing shape (step S34 in FIG. 5 described above) or the like.

The facility information processing unit 83 performs information processing on information regarding a facility targeted for remote work support, and acquires, for example, 3D data of a facility for generating a virtual object.

The application execution unit 84 provides the function of each block of the client terminal 12 illustrated in FIG. 3 described above by executing the remote work support application.

The recording processing unit 85 performs data recording processing on the storage unit 63. The output control unit 86 controls output of an image to the image output unit 64 and output of audio to the audio output unit 65. The communication control unit 87 controls communication with the server 13 via the external communication unit 66.

The storage unit 63 stores various data necessary for processing performed in the control unit 62. The image output unit 64 outputs an image using, for example, a display or the like. The audio output unit 65 outputs audio using, for example, a speaker or the like. The external communication unit 66 communicates with the outside using, for example, a wireless local area network (LAN) or the like.

Note that, in a case where a personal computer is used as the client terminal 12, for example, an input apparatus such as a mouse can be used as the self-position estimation unit 71 of the sensor unit 61. Furthermore, in a case where the AR HMD or the VR HMD is used as the client terminal 12, the sensor unit 61 can include a hand posture estimation unit (for example, a depth sensor, an infrared camera, or the like) for estimating the posture of the hand of the user.

### Processing Example of Pointing UI Processing

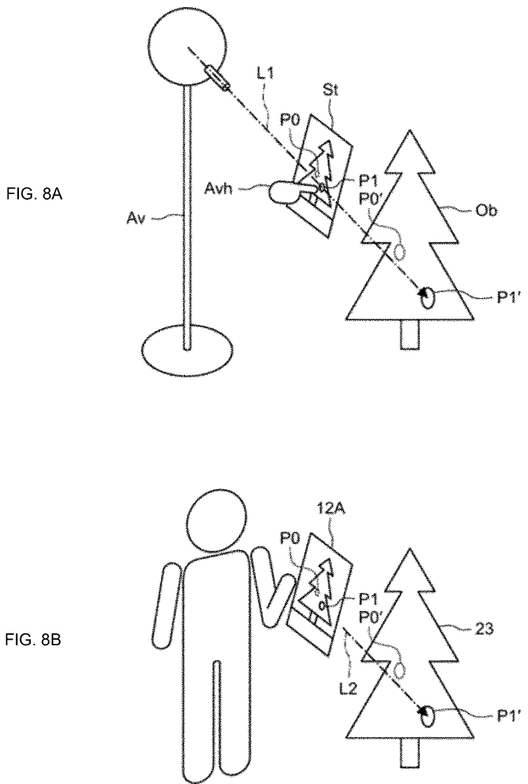

Pointing user interface (UI) processing of appropriately presenting a pointing UI object indicating an instruction portion of an instructor in the remote work support system 11 will be described with reference to FIGS. 8 to 16.

For example, a case will be described in which a worker at a site captures a work target object with the client terminal 12A, and an instructor at a remote place who accesses a VR space of the site indicates an instruction portion for the work target object while viewing a streaming screen corresponding to the worker's client terminal 12A, which is arranged in the VR space. In this case, even if the instructor gives an instruction to the streaming screen arranged in the VR space, since the positions of the streaming screen arranged in the VR space and the real space indicated by the streaming screen are different, it is difficult to appropriately transmit the instruction portion to the worker.

For example, when the instructor points at the streaming screen in the VR space to convey the instruction portion to the worker, the worker sees the instructor pointing at the three-dimensional space ahead of the streaming screen. On the other hand, the worker shows the site through the streaming screen of the client terminal 12A in order to show the work target object to the instructor, but a state in which the instructor is pointing is not displayed on the screen of the client terminal 12A. Furthermore, since the worker receives an instruction while holding the client terminal 12A with one hand, there may be a case where imaging by the client terminal 12A cannot be temporarily performed in order to perform work according to the instruction, and in this case, the instructor cannot check the streaming screen.

Therefore, the remote work support system 11 executes the pointing UI processing of appropriately presenting the pointing UI object indicating the instruction portion of the instructor on the basis of the fingertip position of the hand of the instructor in the VR space and the streaming screen.

FIG. 8 is a diagram for explaining an overview of the pointing UI processing. A of FIG. 8 is a diagram illustrating an example of the VR space of the instructor, and B of FIG. 8 is a diagram illustrating an example of the AR space of the worker.

For example, as illustrated in A of FIG. 8, the avatar Av of the instructor, the avatar Avh of the hand of the instructor, the virtual object Ob corresponding to the work target object 23, and the streaming screen St corresponding to the screen of the client terminal 12A are arranged in the VR space of the instructor.

Then, in a case where the fingertip position of the avatar Avh of the hand of the instructor is in contact with the streaming screen St, in the VR space of the instructor, the pointing UI object P1 is displayed at the passing point where the straight line L1 passing from the head position of the avatar Av of the instructor to the fingertip position of the avatar Avh of the hand of the instructor passes through the streaming screen St, and the pointing UI object P1′ is displayed at the intersection intersecting the surface of the virtual object ob.

At this time, as illustrated in B of FIG. 8, the pointing UI object P1 is displayed in the AR space displayed on the client terminal 12A, and the worker can confirm the pointing UI object P1′ indicating the instruction portion of the instructor with respect to the work target object 23 through the AR space. That is, even if the pointing UI object P1′ is not actually displayed on the work target object 23, the worker can recognize the instruction portion of the instructor by the pointing UI object P1 displayed in the AR space displayed on the client terminal 12A.

Furthermore, in a case where the fingertip position of the avatar Avh of the hand of the instructor is separated from the streaming screen St, the display of the pointing UI object is changed. For example, the pointing UI object P0 represents a past instruction portion, and a color (transparency), a size, and the like are changed from the pointing UI object P1 indicating the current instruction portion, and the pointing UI object P0 is displayed so as not to be more conspicuous than the pointing UI object P1. In the illustrated example, the past instruction portions are indicated by broken lines.

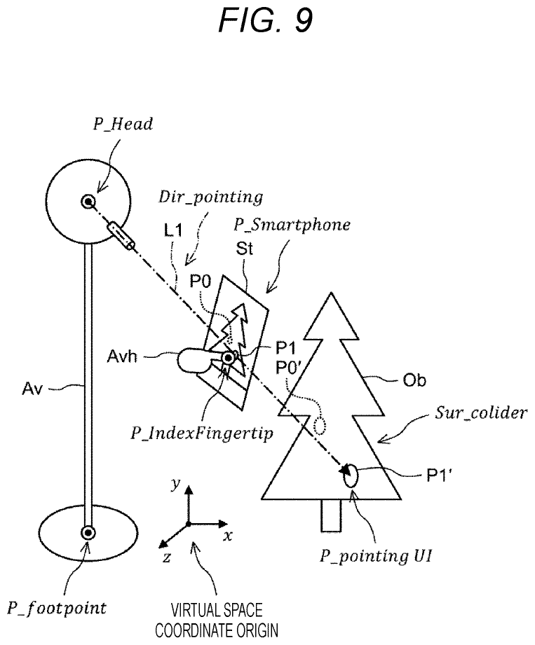

Display of the pointing UI object will be described with reference to FIG. 9.

For example, the head position P_Head of the avatar Av of the instructor can be acquired as the position of the device worn on the head of the instructor in a case where the client terminal 12B is an HMD, and as the position of the virtual camera used by the instructor in a case where the client terminal 12B is a personal computer. The fingertip pointing position P_IndexFingertip of the avatar Avh of the hand of the instructor can be acquired from hand tracking of the device used by the instructor in a case where the client terminal 12B is the HMD, and can be acquired from the fingertip position of the virtual hand calculated from the position of the mouse in a case where the client terminal 12B is the personal computer.

The position P_Smartphone in the VR space of the streaming screen St corresponding to the screen of the client terminal 12A of the worker can acquire the position from the client terminal 12A used by the worker. The virtual foot position P_FootPoint of the avatar Av of the instructor can be estimated (P_FootPoint=P_Head (x, 0, y)) from the head position P_Head and the position of the coordinate origin that defines the virtual space.

The vector component Dir_pointing of the straight line L1 connecting the head position and the fingertip of the instructor can be estimated with a vector component including the head position P_Head and the fingertip position P_IndexFingertip (Dir_pointing=P_IndexFingertip−P_Head). Note that the head position P_Head is used as positional information of the eyes of the instructor. The contact determination surface Sur_colider of the 3D data can be generated on the basis of the mesh of the 3D data of the virtual object Ob. The presentation position P_Pointing UI of the pointing UI object is coordinates of a point at a position closer to the fingertip position P_IndexFingertip among points at which a straight line extending in the direction of the vector component Dir_pointing of the straight line L1 starting from the fingertip position P_IndexFingertip intersects the contact determination surface Sur_colider of the 3D data.

Then, in the pointing UI processing, when the avatar Avh of the hand of the instructor is in the vicinity of the streaming screen St in a state of a predetermined hand shape (for example, finger pointing), the pointing UI object is displayed when the following first to third conditions are satisfied. The first condition is when a trigger word such as “here” is recognized, the second condition is when the avatar Avh of the hand of the instructor contacts the streaming screen St, and the third condition is when the distance between the fingertip of the avatar Avh of the hand of the instructor and the streaming screen St is within a certain distance and a certain period of time has elapsed.

When such a condition is satisfied, the pointing UI object is displayed at a point closer to the fingertip position P_IndexFingertip among points at which the straight line extending in the direction of the vector component Dir_pointing of the straight line L1 starting from the fingertip position P_IndexFingertip intersects the contact determination surface Sur_colider of the 3D data.

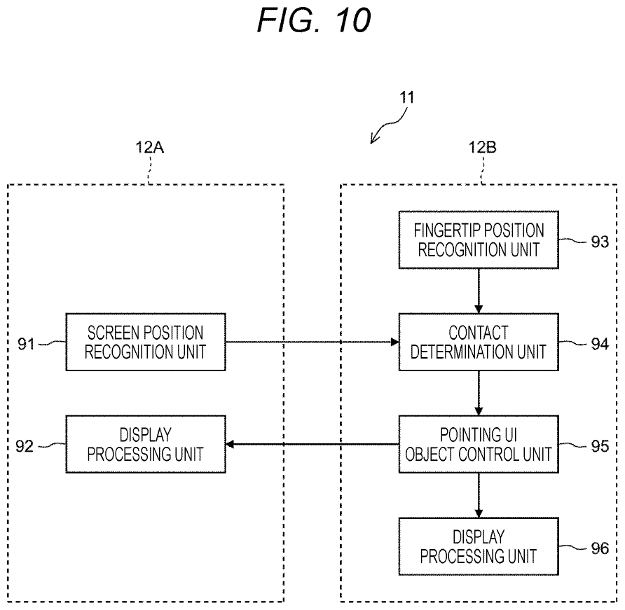

FIG. 10 is a block diagram illustrating a functional configuration example of the client terminal 12A and the client terminal 12B that execute the pointing UI processing.

The client terminal 12A includes a screen position recognition unit 91 and a display processing unit 92. The client terminal 12B includes a fingertip position recognition unit 93, a contact determination unit 94, a pointing UI object control unit 95, and a display processing unit 96.

The screen position recognition unit 91 measures the position and orientation of the client terminal 12A of the worker, recognizes the position in the VR space of the streaming screen St corresponding to the screen of the client terminal 12A of the worker according to the measurement result, and notifies the contact determination unit 94 of the position.

Under the control of the pointing UI object control unit 95, the display processing unit 92 performs display processing of displaying the pointing UI object in the AR space of the client terminal 12A or changing the display of the pointing UI object.

The fingertip position recognition unit 93 recognizes the fingertip pointing position of the avatar Avh of the hand of the instructor, and notifies the contact determination unit 94 of the fingertip pointing position.

The contact determination unit 94 determines whether or not the fingertip position of the avatar Avh of the hand of the instructor is in contact with the streaming screen St on the basis of the fingertip pointing position of the avatar Avh of the hand of the instructor and the position of the streaming screen St in the VR space. Then, in a case where the contact determination unit 94 determines that the fingertip position of the avatar Avh of the hand of the instructor is in contact with the streaming screen St, the contact determination unit 94 notifies the pointing UI object control unit 95 of the fingertip position of the avatar Avh of the hand of the instructor who is in contact with the streaming screen St. Furthermore, in a case where the fingertip position of the avatar Avh of the hand of the instructor has moved away from the streaming screen St, the contact determination unit 94 notifies the pointing UI object control unit 95 of the fact.

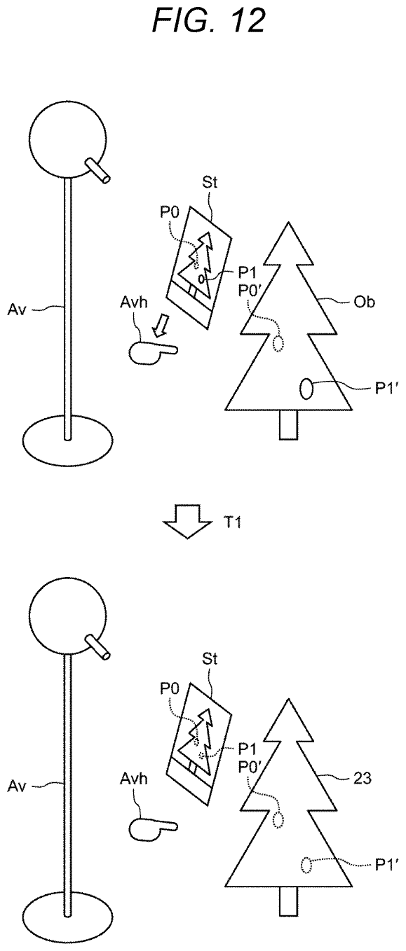

The pointing UI object control unit 95 performs control necessary for displaying the pointing UI object at the instruction portion of the instructor. For example, as described above with reference to FIG. 9, the pointing UI object control unit 95 specifies a point at a position closer to the fingertip position P_IndexFingertip among points at which a straight line extending in the direction of the vector component Dir_pointing of the straight line L1 starting from the fingertip position P_IndexFingertip intersects the contact determination surface Sur_colider of the 3D data. Furthermore, the pointing UI object control unit 95 performs control to change the display of the pointing UI object as described below with reference to FIGS. 12 to 16.

The display processing unit 96 performs display processing of displaying the pointing UI object in the VR space of the client terminal 12B or changing the display of the pointing UI object according to the control by the pointing UI object control unit 95.

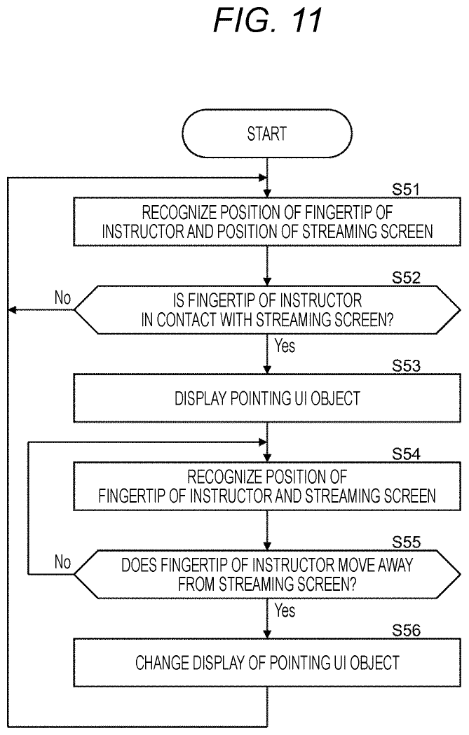

The pointing UI processing executed in the client terminal 12A and the client terminal 12B will be described with reference to the flowchart illustrated in FIG. 11.

In step S51, the fingertip position recognition unit 93 recognizes the fingertip pointing position of the avatar Avh of the hand of the instructor, and notifies the contact determination unit 94 of the fingertip pointing position. The screen position recognition unit 91 measures the position and orientation of the client terminal 12A of the worker, recognizes the position in the VR space of the streaming screen St corresponding to the screen of the client terminal 12A of the worker according to the measurement result, and notifies the contact determination unit 94 of the position.

In step S52, the contact determination unit 94 determines whether or not the fingertip position of the avatar Avh of the hand of the instructor is in contact with the streaming screen St on the basis of the fingertip pointing position of the avatar Avh of the hand of the instructor and the position of the streaming screen St in the VR space.

In step S52, in a case where the contact determination unit 94 determines that the fingertip position of the avatar Avh of the hand of the instructor is not in contact with the streaming screen St, the processing returns to step S51, and similar processing is repeatedly performed thereafter.

On the other hand, in step S52, in a case where the contact determination unit 94 determines that the fingertip position of the avatar Avh of the hand of the instructor is in contact with the streaming screen St, the processing proceeds to step S53.

In step S53, the contact determination unit 94 notifies the pointing UI object control unit 95 of the fingertip position of the avatar Avh of the hand of the instructor in contact with the streaming screen St. The pointing UI object control unit 95 performs control necessary for displaying the pointing UI object at the instruction portion of the instructor. Then, the display processing unit 92 displays the pointing UI object in the AR space of the client terminal 12A under the control of the pointing UI object control unit 95. Similarly, the display processing unit 96 displays the pointing UI object in the VR space of the client terminal 12B under the control of the pointing UI object control unit 95.

In step S54, similarly to step S51, the fingertip position recognition unit 93 recognizes the fingertip pointing position of the avatar Avh of the hand of the instructor, and the screen position recognition unit 91 recognizes the position of the streaming screen St in the VR space.

In step S55, the contact determination unit 94 determines whether or not the fingertip position of the avatar Avh of the hand of the instructor has moved away from the streaming screen St on the basis of the fingertip pointing position of the avatar Avh of the hand of the instructor and the position of the streaming screen St in the VR space.

In step S55, in a case where the contact determination unit 94 determines that the fingertip position of the avatar Avh of the hand of the instructor is not separated from the streaming screen St, the processing returns to step S54, and the display of the pointing UI object is continued.

On the other hand, in step S55, in a case where the contact determination unit 94 determines that the fingertip position of the avatar Avh of the hand of the instructor has moved away from the streaming screen St, the processing proceeds to step S56.

In step S56, the contact determination unit 94 notifies the pointing UI object control unit 95 that the fingertip position of the avatar Avh of the hand of the instructor has moved away from the streaming screen St. The pointing UI object control unit 95 performs control necessary for changing the display of the pointing UI object. Then, the display processing unit 92 changes the color and size of the pointing UI object displayed in the AR space of the client terminal 12A according to the control by the pointing UI object control unit 95. Similarly, the display processing unit 96 changes the color and size of the pointing UI object displayed in the VR space of the client terminal 12B according to the control by the pointing UI object control unit 95.

After the processing of step S56, the processing returns to step S51, and similar processing is repeatedly performed thereafter.

By performing the pointing UI processing as described above, the pointing UI object indicating the instruction portion of the instructor can be appropriately presented.

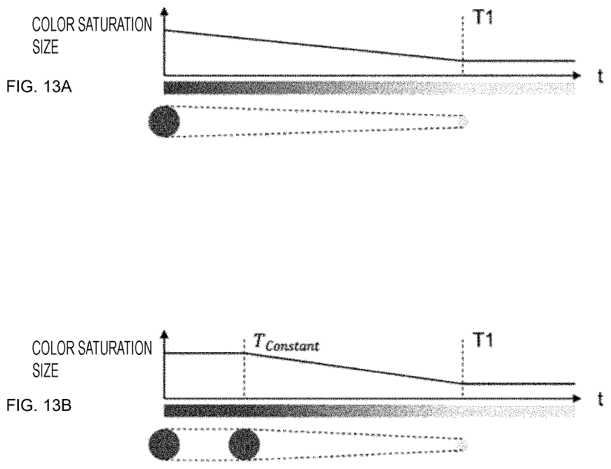

The change in the display of the pointing UI object with the lapse of time will be described with reference to FIGS. 12 and 13.

In the pointing UI processing, the display of the pointing UI object can be changed with the lapse of time after the fingertip position of the avatar Avh of the hand of the instructor comes into contact with the streaming screen St or the lapse of time after the fingertip position of the avatar Avh of the hand of the instructor separates from the streaming screen St.

For example, as described above with reference to FIG. 8, the pointing UI object is displayed in response to the fingertip position of the avatar Avh of the hand of the instructor coming into contact with the streaming screen St. Thereafter, as illustrated in the upper side of FIG. 12, in a case where the fingertip position of the avatar Avh of the hand of the instructor is separated from the streaming screen St by a certain distance (for example, 5 cm) or more, the display of the pointing UI object is not changed immediately after the separation. Then, after the fingertip position of the avatar Avh of the hand of the instructor is separated from the streaming screen St and a certain period of time T1 has elapsed, the display of the pointing UI object is changed (in the illustrated example, the solid line is changed to the broken line).

As illustrated in A of FIG. 13, the timing at which the fingertip position of the avatar Avh of the hand of the instructor is separated from the streaming screen St is set to t=0, and the change in saturation and magnitude of the color (including transmittance) of the pointing UI object may change (Color=const×F (t, T1)) at a certain rate until a certain period of time T1 elapses.

Alternatively, as illustrated in B of FIG. 13, the saturation and magnitude of the color (including transmittance) of the pointing UI object may be maintained constant from the timing at which the fingertip position of the avatar Avh of the hand of the instructor is separated from the streaming screen St until the predetermined time T_{constant} (<T1) elapses, and may be changed at a certain rate until the certain period of time T1 elapses after the predetermined time T_{constant} elapses.

In this manner, the pointing UI object control unit 95 can perform control to change the display of the pointing UI object with the lapse of time. As a result, the past pointing UI object can be made less conspicuous.

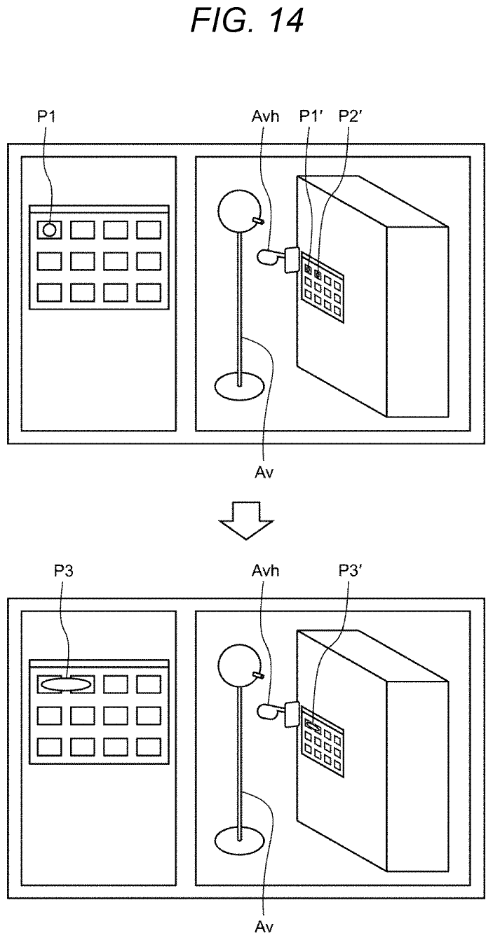

With reference to FIG. 14, display change according to a plurality of pointing UI objects existing within a certain range will be described.

In the pointing UI processing, the display of the pointing UI object can be changed as the plurality of pointing UI objects exists within the certain range.

For example, as illustrated in the upper side of FIG. 14, a case will be described in which an instruction to newly display the pointing UI object P2 is issued subsequently to the display of the pointing UI object P1. In this case, when the pointing UI object P1 exists within a certain distance (for example, within 2.5 cm) from the pointing UI object P2, the display may be changed so that the pointing UI object P3 having a size that covers the pointing UI object P1 and the pointing UI object P2 is displayed as illustrated in the lower part of FIG. 14 without displaying the pointing UI object P2.

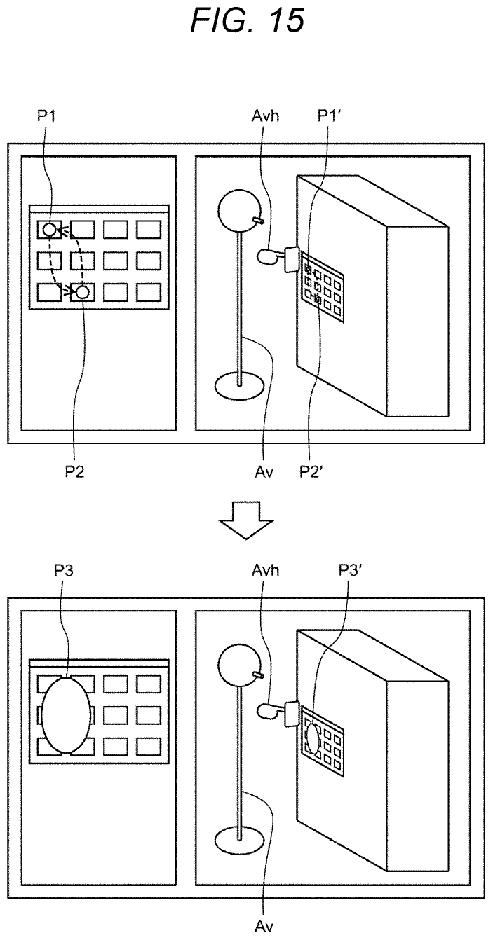

With reference to FIG. 15, a change will be described in which, in a case where there is a plurality of pointing UI objects within a range of a certain distance, a pointing UI object having a size that covers the pointing UI objects is displayed.

In the pointing UI processing, in a case where there is a plurality of pointing UI objects within a range of a certain distance, the size of the pointing UI object closest to the barycentric position can be changed to a size that covers all the pointing UI objects. For example, the certain distance and the barycentric positions of the plurality of pointing UI objects can be calculated from the trajectory of the fingertip of the avatar Avh of the hand of the instructor.

Furthermore, as illustrated in FIG. 15, in a case where the motion in which the trajectory of the fingertip of the avatar Avh of the hand of the instructor passes through the pointing UI object P1 and the pointing UI object P2 and traces the same range in circles many times is performed, the pointing UI object P3 having a size that covers the trajectory of the fingertip may be displayed. At this time, the measurement start point of the trajectory of the fingertip of the avatar Avh of the hand of the instructor can be the fingertip position at the time when the trigger word such as “from here” is recognized, and the measurement end point can be the fingertip position at the time when the trigger word such as “up to here” is recognized.

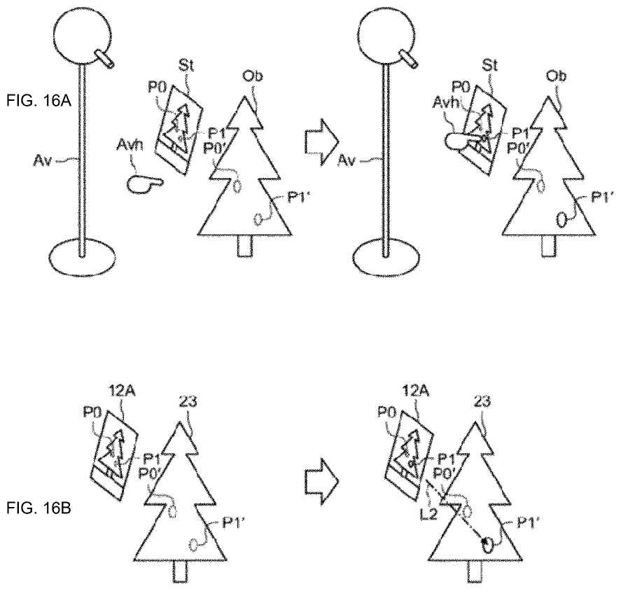

The pointing UI processing of changing the past pointing UI object to be displayed in the original conspicuous state will be described with reference to FIG. 16. A of FIG. 16 is a diagram illustrating an example of the VR space of the instructor, and B of FIG. 16 is a diagram illustrating an example of the AR space of the worker.

In the pointing UI processing, as illustrated on the left side of FIG. 16, the display is changed so that the past pointing UI object is less conspicuous. Thereafter, in a case where the instructor moves the hand to the range in which the past pointing UI object is presented and the pointing determination to instruct again is made, it is possible to change the color, transparency, and the like of the pointing UI object and display the pointing UI object so as to be in the original conspicuous state as illustrated on the right side of FIG. 16.

As described above, by the pointing UI processing, the pointing UI object indicating the instruction portion of the instructor can be displayed on the virtual space accompanied by the 3D data of the site on the basis of the position of the hand of the instructor and the device position of the worker. As a result, the instructor at the remote place can instruct the instruction portion only by pointing at the streaming screen at the site on the virtual space, and it is possible to perform remote work support that is more sensible and easy to understand.

Furthermore, in the pointing UI processing, the color and size of the pointing UI object can be changed by the elapsed time from the time point at which the pointing UI object is instructed and the number of instruction portions existing within a certain range. As a result, the past pointing UI object that is not currently necessary can be changed so as to be gradually less conspicuous by the elapsed time. Therefore, the number of pointing UI objects standing out on the virtual space is reduced, and both the worker and the instructor can easily understand which instruction should be currently viewed.

Furthermore, in the pointing UI processing, in a case where the hand of the instructor is moved again to the range in which the past pointing UI object is presented and the pointing determination is made, the color, transparency, and the like of the pointing UI object can be changed to be conspicuous. As a result, since the pointing UI object can be re-emphasized as necessary, the instructor can perform remote work support utilizing the records of previously given instructions.

### Application Example of Remote Work Support System

For example, in a case where the remote work support system 11 is used at a building site or a construction site, a worker at the site can capture a state of a building, a facility, or the like, and can remotely confirm, instruct, and support the state. In addition, in a case where the remote work support system 11 is used in agriculture, a worker at a site can capture the state of crops and fields of the agricultural farm in the agricultural farm, and confirmation, instructions, and support can be performed remotely. In addition, in a case where the remote work support system 11 is used in medical care, it is possible for a person at a site to capture the state and arrangement of a facility in an operating room or a place where medical equipment is present, or for a doctor or a nurse to capture the state of a patient or the state of peripheral equipment in an ICU, an operating room, or the like, and it is possible to remotely confirm, instruct, and support them.

In addition, in a case where the remote work support system 11 is used for urban maintenance or landscape construction, a person at a site can capture an image of the maintenance status, arrangement, landscape, or the like of the city, and the remote work support system can remotely check, instruct, and support the image. In addition, in a case where the remote work support system 11 is used in a commercial facility, it is possible to capture a facility layout, a product display, a sales status, and the like in a store, and it is possible to remotely confirm, instruct, and support the facility layout, the product display, the sales status, and the like.

Note that the remote work support system 11 may be used not only for remote confirmation, instruction, and support but also for confirmation before and after work only at the site or the like, for example.

### Configuration Example of Computer

Next, the above-described series of processing (information processing method) can be performed by hardware or software. In a case where the series of processing is performed by software, a program constituting the software is installed in a general-purpose computer or the like.

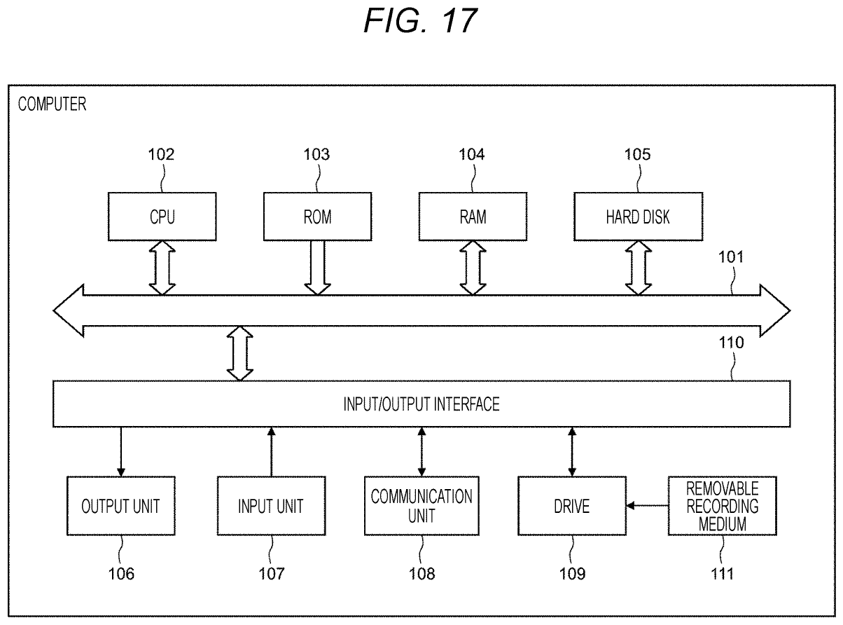

FIG. 17 is a block diagram illustrating a configuration example of an embodiment of a computer in which a program for executing the above-described series of processing is installed.

The program can be recorded in advance in a hard disk 105 or a ROM 103 as a recording medium built in the computer.

Alternatively, the program can be stored (recorded) in a removable recording medium 111 driven by a drive 109. Such a removable recording medium 111 can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 111 as described above, or can be downloaded to the computer via a communication network or a broadcast network and installed in the built-in hard disk 105. That is, for example, the program can be wirelessly transferred from a download site to the computer via an artificial satellite for digital satellite broadcasting, or can be transferred by wire to the computer via a network such as a local area network (LAN) or the Internet.

The computer incorporates a central processing unit (CPU) 102, and an input/output interface 110 is connected to the CPU 102 via a bus 101.

When a command is input by a user operating an input unit 107 or the like via the input/output interface 110, the CPU 102 executes a program stored in a read only memory (ROM) 103 according to the command. Alternatively, the CPU 102 loads the program stored in the hard disk 105 into a random access memory (RAM) 104 and executes the program.

As a result, the CPU 102 performs the processing according to the above-described flowcharts or the processing performed by the configuration of the above-described block diagram. Then, the CPU 102 outputs the processing result from the output unit 106, transmits the processing result from the communication unit 108, or records the processing result in the hard disk 105 or the like via the input/output interface 110, for example, as necessary.

Note that the input unit 107 includes a keyboard, a mouse, a microphone, and the like. Furthermore, the output unit 106 includes a liquid crystal display (LCD), a speaker, and the like.

Here, in the present specification, the processing performed by the computer according to the program is not necessarily performed in time series in the order described as the flowcharts. That is, the processing performed by the computer according to the program also includes processing executed in parallel or individually (for example, parallel processing or processing by an object).

Furthermore, the program may be processed by one computer (processor) or may be processed in a distributed manner by a plurality of computers. Furthermore, the program may be transferred to a remote computer and executed.

Furthermore, in the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Furthermore, for example, a configuration described as one apparatus (or processing unit) may be divided and configured as a plurality of apparatuses (or processing units). Conversely, configurations described above as a plurality of apparatuses (or processing units) may be collectively configured as one apparatus (or processing unit). Furthermore, a configuration other than the above-described configuration may be added to the configuration of each apparatus (or each processing unit).

Furthermore, as long as the configuration and operation of the entire system are substantially the same, a part of the configuration of a certain apparatus (or processing unit) may be included in the configuration of another apparatus (or another processing unit).

Furthermore, for example, the present technology can have a configuration of cloud computing in which one function is shared and processed in cooperation by a plurality of apparatuses via a network.

Furthermore, for example, the above-described program can be executed in an arbitrary apparatus. In that case, it is sufficient that the apparatus has a necessary function (functional block or the like) and can obtain necessary information.

Furthermore, for example, each step described in the above-described flowcharts can be executed by one apparatus or can be shared and executed by a plurality of apparatuses. Furthermore, in a case where a plurality of processes is included in one step, the plurality of processes included in the one step can be executed by one apparatus or can be shared and executed by a plurality of apparatuses. In other words, a plurality of processes included in one step can also be executed as processes of a plurality of steps. Conversely, the processing described as a plurality of steps can be collectively executed as one step.

Note that, in the program executed by the computer, processing of steps describing the program may be executed in time series in the order described in the present specification, or may be executed in parallel or individually at necessary timing such as when a call is made. That is, as long as there is no contradiction, the processing of each step may be executed in an order different from the above-described order. Furthermore, the processing of steps describing this program may be executed in parallel with the processing of another program, or may be executed in combination with the processing of another program.

Note that a plurality of the present technologies described in the present specification can be implemented independently as a single body as long as there is no contradiction. Of course, a plurality of arbitrary present technologies can be implemented in combination. For example, some or all of the present technology described in any of the embodiments can be implemented in combination with some or all of the present technology described in other embodiments. Furthermore, some or all of the above-described arbitrary present technology can be implemented in combination with other technologies not described above.

### Combination Example of Configuration

Note that the present technology can also have the following configurations.

(1)

An information processing apparatus including:
an update image acquisition unit that acquires an update image to be used for updating 3D data among images obtained by capturing a work target object;
an update part specification unit that compares the 3D data of the work target object already created with the update image to specify an update part of the 3D data of the work target object; and
a 3D data update unit that updates a part of the 3D data of the work target object using the update image.
   (2)

The information processing apparatus according to (1), further including
a trigger recognition unit that recognizes generation of an update image acquisition trigger that is a trigger for acquiring the update image, in which
the update image acquisition unit acquires the update image from an image of a certain period before and after generation of the update image acquisition trigger is recognized.
   (3)

The information processing apparatus according to (2), in which
the trigger recognition unit recognizes generation of the update image acquisition trigger on the basis of a conversation between a worker who performs work on the work target object and an instructor who instructs the worker from a remote place.
   (4)

The information processing apparatus according to (3), in which
in a case where it is detected that a body part of the worker is shown in an image on the basis of an analysis result obtained by analyzing the image, the update image acquisition unit sets an image section before and after the body part is not shown or an image region in which the body part is not shown as the update image.
   (5)

The information processing apparatus according to (3), in which
in a case where a hand of the worker shown in the image has a pointing shape and an object exists within a certain range of a point pointed by the worker, on the basis of an analysis result obtained by analyzing the image, the update image acquisition unit sets an image including the object as the update image.
   (6)

The information processing apparatus according to any one of (1) to (5), in which
the update part specification unit performs feature point matching between the 3D data of the work target object that has already been created and the update image, and specifies the update part in a case where a matching degree of the feature point matching is a set value or more.
   (7)

The information processing apparatus according to any one of (1) to (6), further including:
a determination unit that, when an avatar of a hand of an instructor who gives an instruction to a worker who performs work on the work target object from a remote place is in a vicinity of a streaming screen corresponding to a screen of a terminal of the worker in a VR space of the instructor in a state where the avatar is in a form of a predetermined hand, determines that the instructor has given an instruction on an instruction portion when a specific condition is satisfied; and
a pointing UI object control unit that controls display of a pointing UI object indicating the instruction portion.
   (8)

The information processing apparatus according to (7), in which
in a case where a fingertip position of the avatar of the hand of the instructor is in contact with the streaming screen, the determination unit determines that the instructor has designated the instruction portion.
   (9)

The information processing apparatus according to (7) or (8), in which
the pointing UI object control unit displays the pointing UI object with a point at which a straight line passing from a head position of the avatar of the instructor to a fingertip position of the avatar of the hand of the instructor in the VR space intersects a surface of a virtual object of the work target object as the instruction portion.
   (10)

The information processing apparatus according to any one of (7) to (9), in which
the pointing UI object control unit changes display of the pointing UI object according to an elapsed time from a timing at which the instruction of the instruction portion by the instructor ends.
   (11)

The information processing apparatus according to any one of (7) to (10), in which
in a case where a plurality of the pointing UI objects exists within a certain range, the pointing UI object control unit displays the pointing UI object having a size that covers all the pointing UI objects.
   (12)

The information processing apparatus according to any one of (1) to (11), in which
in a case where the pointing UI object in a past is instructed again, the pointing UI object control unit displays the pointing UI object in an original state.
   (13)

An information processing method including:
by an information processing apparatus,
acquiring an update image to be used for updating 3D data among images obtained by capturing a work target object;
comparing the 3D data of the work target object already created with the update image to specify an update part of the 3D data of the work target object; and
updating a part of the 3D data of the work target object using the update image.
   (14)

A program for causing
a computer of an information processing apparatus to execute information processing including:
acquiring an update image to be used for updating 3D data among images obtained by capturing a work target object;
comparing the 3D data of the work target object already created with the update image to specify an update part of the 3D data of the work target object; and
updating a part of the 3D data of the work target object using the update image.

Note that the present embodiment is not limited to the above-described embodiments, and various modifications can be made without departing from the gist of the present disclosure. Furthermore, the effects described in the present specification are merely examples and are not limited, and other effects may be provided.

### REFERENCE SIGNS LIST

11 Remote work support system
12 Client terminal
13 Server
14 Storage unit
41 Data determination unit
42 Virtual object generation unit
43 Flag setting unit
44 3D data request unit
45 Trigger recognition unit
46 Image acquisition unit
47 Image analysis unit
48 Update image transmission unit
51 Data determination unit
52 3D data transmission unit
53 Feature point matching processing unit
54 3D data update unit
61 Sensor unit
62 Control unit
63 Storage unit
64 Image output unit
65 Audio output unit
66 External communication unit
71 Self-position estimation unit
72 Audio acquisition unit
73 Image acquisition unit
81 Self-position estimation processing unit
82 Person/hand posture detection unit
83 Facility information processing unit
84 Application execution unit
85 Recording processing unit
86 Output control unit
87 Communication control unit
91 Screen position recognition unit
92 Display processing unit
93 Fingertip position recognition unit
94 Contact determination unit
95 Pointing UI object control unit
96 Display processing unit

1. An information processing apparatus comprising:
an update image acquisition unit that acquires an update image to be used for updating 3D data among images obtained by capturing a work target object;
an update part specification unit that compares the 3D data of the work target object already created with the update image to specify an update part of the 3D data of the work target object; and
a 3D data update unit that updates a part of the 3D data of the work target object using the update image.

2. The information processing apparatus according to claim 1, further comprising
a trigger recognition unit that recognizes generation of an update image acquisition trigger that is a trigger for acquiring the update image, wherein
the update image acquisition unit acquires the update image from an image of a certain period before and after generation of the update image acquisition trigger is recognized.

3. The information processing apparatus according to claim 2, wherein
the trigger recognition unit recognizes generation of the update image acquisition trigger on a basis of a conversation between a worker who performs work on the work target object and an instructor who instructs the worker from a remote place.

4. The information processing apparatus according to claim 3, wherein
in a case where it is detected that a body part of the worker is shown in an image on a basis of an analysis result obtained by analyzing the image, the update image acquisition unit sets an image section before and after the body part is not shown or an image region in which the body part is not shown as the update image.

5. The information processing apparatus according to claim 3, wherein
in a case where a hand of the worker shown in the image has a pointing shape and an object exists within a certain range of a point pointed by the worker, on a basis of an analysis result obtained by analyzing the image, the update image acquisition unit sets an image including the object as the update image.

6. The information processing apparatus according to claim 1, wherein
the update part specification unit performs feature point matching between the 3D data of the work target object that has already been created and the update image, and specifies the update part in a case where a matching degree of the feature point matching is a set value or more.

7. The information processing apparatus according to claim 1, further comprising:
a determination unit that, when an avatar of a hand of an instructor who gives an instruction to a worker who performs work on the work target object from a remote place is in a vicinity of a streaming screen corresponding to a screen of a terminal of the worker in a VR space of the instructor in a state where the avatar is in a form of a predetermined hand, determines that the instructor has given an instruction on an instruction portion when a specific condition is satisfied; and
a pointing UI object control unit that controls display of a pointing UI object indicating the instruction portion.

8. The information processing apparatus according to claim 7, wherein
in a case where a fingertip position of the avatar of the hand of the instructor is in contact with the streaming screen, the determination unit determines that the instructor has designated the instruction portion.

9. The information processing apparatus according to claim 7, wherein
the pointing UI object control unit displays the pointing UI object with a point at which a straight line passing from a head position of the avatar of the instructor to a fingertip position of the avatar of the hand of the instructor in the VR space intersects a surface of a virtual object of the work target object as the instruction portion.

10. The information processing apparatus according to claim 7, wherein
the pointing UI object control unit changes display of the pointing UI object according to an elapsed time from a timing at which the instruction of the instruction portion by the instructor ends.

11. The information processing apparatus according to claim 7, wherein
in a case where a plurality of the pointing UI objects exists within a certain range, the pointing UI object control unit displays the pointing UI object having a size that covers all the pointing UI objects.

12. The information processing apparatus according to claim 7, wherein
in a case where the pointing UI object in a past is instructed again, the pointing UI object control unit displays the pointing UI object in an original state.

13. An information processing method comprising:
by an information processing apparatus,
acquiring an update image to be used for updating 3D data among images obtained by capturing a work target object;
comparing the 3D data of the work target object already created with the update image to specify an update part of the 3D data of the work target object; and
updating a part of the 3D data of the work target object using the update image.

14. A program for causing
a computer of an information processing apparatus to execute information processing including:
acquiring an update image to be used for updating 3D data among images obtained by capturing a work target object;
comparing the 3D data of the work target object already created with the update image to specify an update part of the 3D data of the work target object; and
updating a part of the 3D data of the work target object using the update image.
